(19) United States
(12) Patent Application Publication
(10) Pub. No.: US 2026/0138634 A1
(43) Pub. Date: May 21, 2026

(54) AUTONOMOUS VEHICLE AND AUTONOMOUS DRIVING METHOD FOR VEHICLE

(71) Applicants: Hyundai Motor Company, Seoul (KR); Kia Corporation, Seoul (KR)

(72) Inventors: Yun Hyeok NAM, Hwaseong-Si (KR); Myung Soo LEE, Hwaseong-Si (KR); Hyeon Ji KIM, Hwaseong-Si (KR); Sang Ho SHIN, Hwaseong-Si (KR); Chan Ryeol KIM, Hwaseong-Si (KR)

(21) Appl. No.: 19/284,050

(22) Filed: Jul. 29, 2025

(30) Foreign Application Priority Data
Nov. 21, 2024 (KR) 10-2024-0167501

(51) Int. Cl. B60W 50/16; B60W 30/09; B60W 30/095; B60W 30/182; B60W 40/08; B60W 50/00; B60W 50/14; B60W 60/00; G06V 20/59; G06V 40/18

(52) U.S. Cl. CPC B60W 50/16; B60W 30/09; B60W 30/0956; B60W 30/182; B60W 40/08; B60W 60/0015; G06V 20/597; G06V 40/18; B60W 2040/0818; B60W 2050/0083; B60W 2050/143; B60W 2050/146; B60W 2420/403; B60W 2420/408; B60W 2540/225; B60W 2540/229; B60W 2554/4041; B60W 2554/4042; B60W 2554/80; B60W 2556/20; B60W 2556/35

(57) ABSTRACT

An apparatus of a vehicle may comprise a processor and a memory storing at least one instruction that, when executed by the processor communicating with the memory, is configured to cause the apparatus to identify a potential target within a threshold distance from the vehicle, determine, based on the potential target, whether the vehicle is in a dangerous situation, determine, based on data from a sensor of the vehicle, whether a driver of the vehicle is careless, and, based on determining that the vehicle is in the dangerous situation and the driver is careless, control at least one output interface of the vehicle to output a warning signal to the driver.

### CROSS-REFERENCE TO RELATED APPLICATION

This application claims the benefit of priority to Korean Patent Application No. 10-2024-0167501, filed in the Korean Intellectual Property Office on Nov. 21, 2024, the entire contents of which are incorporated herein by reference.

### TECHNICAL FIELD

The present disclosure relates to an autonomous vehicle and an autonomous driving method for a vehicle, and more particularly, to an autonomous vehicle and an autonomous driving method for a vehicle capable of preventing an accident caused by carelessness of a driver in a vehicle using a driver assistance function.

### BACKGROUND

The matters described in this Background section are only for enhancement of understanding of the background of the disclosure, and should not be taken as acknowledgment that they correspond to prior art already known to those skilled in the art.

An autonomous vehicle may include a vehicle terminal corresponding to an autonomous driving device built into various means for transportation to perform autonomous driving by searching for a driving position. Such an autonomous driving device has mainly been applied to a ship, an aircraft, etc., and has been applied to a vehicle driven on a road to, for example, inform a user of various information such as a driving route, road congestion, etc. through a monitor, autonomously drive the vehicle, or control a driving condition.

Such an autonomous vehicle may use a driver assistance function for autonomous driving such as SCC 2 (Smart Cruise Control 2) or HDA 2 (Highway Driving Assist 2).

However, since SCC 2 or HDA 2 does not implement a full autonomous driving function, an accident may occur due to carelessness of a driver, such as not paying attention to the front. To prevent this problem, a separate function may be implemented.

SCC 2 is a driving convenience function that assists in recognizing a target using sensors such as a front radar and a front camera, maintaining a distance from a vehicle in front during driving, and driving at a speed set by the driver. Upon determining that the driver is in an unresponsive state using an indoor camera, etc., it may be possible to perform an emergency stop function by performing deceleration control while maintaining a center of a lane and stopping the vehicle in the lane.

HDA 2 is a driving convenience function that assists in maintaining a distance from a vehicle in front while driving on a highway and an expressway and assists in driving while maintaining a center of a lane even on a curved road at a speed set by the driver. A sensor such as a front-side radar may be used to respond to a vehicle entering a lane in which the vehicle is driven at a low speed within a close range, and the vehicle is driven in a biased manner to avoid danger if a vehicle next to the subject vehicle is getting closer. In addition, for safety of the user, the user may be warned when driving without gripping a steering wheel. If the user still does not grip the steering wheel, the function of HDA 2 may be deactivated.

As such, SCC 2 and HDA 2 include preventive measures to prevent accidents caused by carelessness of the driver. However, there are the following problems.

The driver assistance function such as the above-mentioned SCC 2 or HDA 2 may have a grace period to determine careless behavior in order to suppress excessive warnings for the careless driver (for example, not paying attention to the front, not gripping the steering wheel, etc.). Therefore, the driver may be warned if carelessness continues for a certain period of time.

Therefore, if the driver is repeatedly careful/careless (for example, repeatedly gripping and not gripping the steering wheel) within the grace period, the driver assistance function may continue to be used without receiving a separate warning. Thus, the driver becomes more dependent on the driver assistance function, leading to neglect of forward attention, which may create or increase a risk of accidents. In fact, traffic accidents involving vehicles driven using driver assistance functions and resulting deaths have been increasing.

In addition, the driver assistance function may select a control target by utilizing various sensors such as a front camera, a front radar, and a front/rear side radar, and it may be necessary to prevent malfunction of the function due to false target detection.

In addition, time delay may occur in a process of selecting a reliable target for each sensor, and due to performance limitations of hardware related to the sensor, for example, the target may not be recognized in a certain situation, such as inside a tunnel having many reflectors, or in an unexpected situation.

### SUMMARY

Accordingly, the present disclosure is directed to an autonomous vehicle and an autonomous driving method for a vehicle that substantially obviate one or more problems due to limitations and disadvantages of the related art.

The present disclosure is intended to solve the above-mentioned problems and provides an autonomous vehicle and an autonomous driving method for a vehicle that reduce a risk of accidents caused by driver carelessness while using a driver assistance function.

Additional advantages, objects, and features of the disclosure will be set forth in part in the description which follows and in part will become apparent to those having ordinary skill in the art upon examination of the following or may be learned from practice of the disclosure.

According to the present disclosure, an apparatus of a vehicle, the apparatus may comprise, a processor, and a memory storing at least one instruction that, when executed by the processor communicating with the memory, is configured to cause the apparatus to, identify a potential target within a threshold distance from the vehicle, determine, based on the potential target, whether the vehicle is in a dangerous situation, determine, based on data from a sensor of the vehicle, whether a driver of the vehicle is careless, and based on determining that the vehicle is in the dangerous situation and the driver is careless, control at least one output interface of the vehicle to output a warning signal to the driver.

The at least one instruction, when executed by the processor communicating with the memory, is configured to cause the apparatus to communicate with at least one of a front camera, a front radar, a front-side radar, or a navigation system, wherein the front camera, the front radar, the front-side radar, and the navigation system are installed in a front portion of the vehicle.

The at least one instruction, when executed by the processor communicating with the memory, is configured to cause the apparatus to communicate with at least one of an indoor camera or an Audio, Video & Navigation (AVN), wherein the indoor camera and the AVN are installed in the vehicle.

The at least one instruction, when executed by the processor communicating with the memory, is configured to cause the apparatus to control at least one of an instrument cluster of the vehicle, a steering wheel of the vehicle, or a seat belt of the vehicle.

The potential target is identified based on a criterion that is less stringent than a criterion used for identifying a control target, and wherein the control target refers to an object selected using sensor fusion with a higher threshold of confidence than the potential target.

According to the present disclosure, a method performed by an apparatus of a vehicle may comprise, setting, based on determining that a driver of the vehicle is careless, the vehicle to a user setting mode, identifying, based on the user setting mode, a potential target within a threshold distance from the vehicle, determining, based on the potential target, whether the vehicle is in a dangerous situation, and based on determining that the vehicle is in the dangerous situation, controlling at least one output interface of the vehicle to output a warning signal to the driver of the vehicle.

The setting may comprise, estimating a time amount of the driver being careless, guiding the driver to pay attention to a front of the vehicle, and setting, based on the time amount exceeding a preset time, the vehicle to the user setting mode.

The identifying of the potential target may comprise identifying the potential target using a front-side measurement device installed in the vehicle, and wherein the potential target is identified based on a criterion that is less stringent than a criterion used for identifying a control target.

The controlling may comprise outputting the warning signal to the driver of the vehicle using at least one of an instrument cluster of the vehicle, a steering wheel of the vehicle, or a seat belt of the vehicle.

The front-side measurement device is at least one of a front camera of the vehicle or a front radar of the vehicle, and the control target is identified based on satisfying a first reliability threshold, and the potential target is identified based on satisfying a second reliability threshold that is lower than the first reliability threshold.

The method may further comprise, based on a consistency between physical values measured by the front camera and the front radar being satisfactory, determining that a reliability value associated with the control target satisfies the first reliability threshold.

The physical values comprise at least one of a longitudinal position of a detected object, a lateral position of the detected object, a speed of the detected object, or a heading angle of the detected object, wherein the detected object is the control target.

The identifying of the potential target may comprise, determining, based on sensor measurements, a reliability value by applying a weight to a lateral position of the control target or a lateral position of the potential target, and wherein the lateral position of the control target or the lateral position of the potential target are measured by a front camera of the vehicle.

The identifying of the potential target may comprise, determining, based on sensor measurements, a reliability value by applying a weight to a longitudinal position of the control target or a longitudinal position of the potential target, wherein the longitudinal position of the control target or the longitudinal position of the potential target are measured by a front radar of the vehicle.

The identifying of the potential target may comprise selecting another vehicle located in a lane adjacent to a driving lane of the vehicle as the potential target based on the other vehicle encroaching into the driving lane of the vehicle by at least a first threshold amount.

The vehicle is being driven on a highway section, and the potential target may comprise at least one of a stagnation zone, a construction zone, or an accident occurrence point, wherein each of the stagnation zone, the construction zone, and the accident occurrence point is identified based on information received from a navigation system of the vehicle.

The potential target is an obstacle on a road on which the vehicle is being driven.

The method, wherein the potential target is an obstacle on a road on which the vehicle is being driven, and the potential target is identified based on avoidance driving movements of a preceding vehicle traveling ahead of the vehicle.

According to the present disclosure, an apparatus of a vehicle may comprise, a processor, and a memory storing at least one instruction that, when executed by the processor communicating with the memory, is configured to cause the apparatus to, determine that a cumulative carelessness time of a driver of the vehicle exceeds a threshold time, set, based on the determination, the vehicle to a user setting mode, receive sensor data indicating a surrounding environment within a threshold distance from the vehicle, identify, based on the sensor data, a potential target, wherein the potential target is identified using a criterion that is less stringent than a criterion used for identifying a control target, determine, based on the potential target, whether the vehicle is in a dangerous situation, and based on determining that the driver is careless and that the vehicle is in the dangerous situation, control an output device of the vehicle to output a warning signal to the driver.

The at least one instruction, when executed by the processor communicating with the memory, is configured to cause the apparatus to determine the cumulative carelessness time based on gaze information of the driver obtained from an indoor camera of the vehicle, wherein the driver is determined to be careless based on a duration during which the driver does not gaze forward exceeding a gaze threshold time, and wherein the cumulative carelessness time is incremented based on the duration exceeding the gaze threshold time.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate example(s) of the disclosure and together with the description serve to explain the principle of the disclosure. In the drawings:

FIG. 1 shows an example of a configuration of an autonomous vehicle according to an example of the present disclosure;

FIG. 2 shows an example of an autonomous driving method for a vehicle according to an example of the present disclosure; and

FIG. 3 shows an example of creation of a suspected target of FIG. 2.

### DETAILED DESCRIPTION

Hereinafter, some examples of the present disclosure will be described in detail with reference to illustrative drawings. When adding reference numerals to components in each drawing, it should be noted that identical components are given the same reference numerals as much as possible even when the components are shown in different drawings. In addition, when describing examples of the present disclosure, when a specific description of a related known structure or function is determined to hinder understanding of the examples of the present disclosure, the detailed description will be omitted.

In the description of the examples according to the present disclosure, when an element is described as being formed “on or under” another element, the two elements may be directly in contact with each other or may be indirectly formed with one or more other elements disposed therebetween. In addition, when the expression “on or under” is used, a direction thereof may include a downward direction as well as an upward direction based on one element.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, a “controller” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of identifying a potential target and determining a vehicle being in a dangerous situation) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of identifying a potential target and determining a vehicle being in a dangerous situation) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of identifying a potential target and determining a vehicle being in a dangerous situation) described herein.

Minimum risk maneuver (MRM) operation(s) may also be controlled, for example, based on one or more features (e.g., feature of identifying a potential target and determining a vehicle being in a dangerous situation) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of identifying a potential target and determining a vehicle being in a dangerous situation) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of identifying a potential target and determining a vehicle being in a dangerous situation) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous vehicle and an autonomous driving method for a vehicle according to the present disclosure use a driver assistance function so that an existing control target selection condition may be relaxed to create a new suspicious target when a driver is careless during driving, for example, the driver does not grip a steering wheel or pay attention to the front, and a separate warning may be created to draw the attention of the driver when a suspicious target is recognized or a dangerous situation is detected.

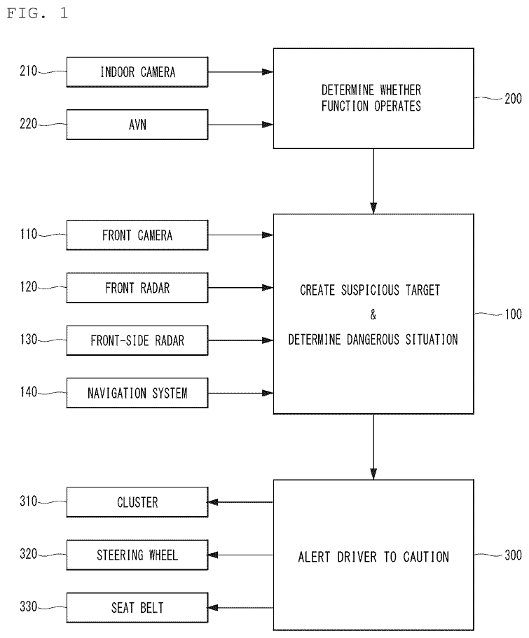

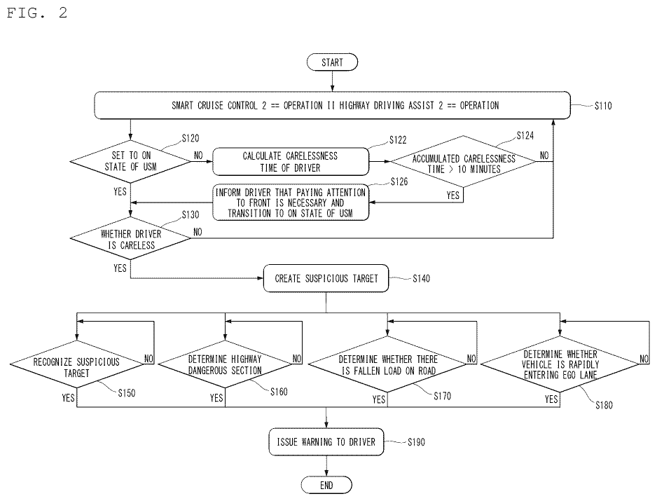

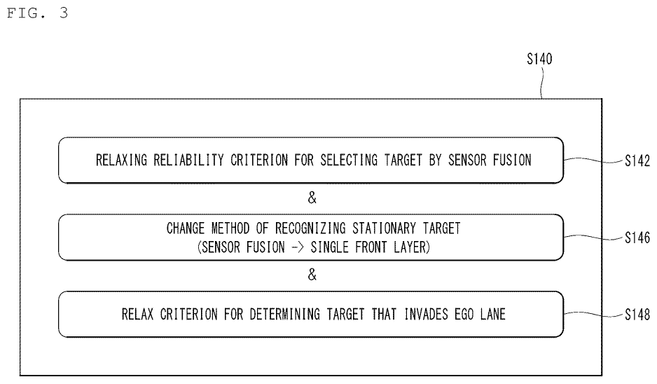

FIG. 1 shows an example of a configuration of an autonomous vehicle according to an example of the present disclosure. FIG. 2 shows an example of an autonomous driving method for a vehicle according to an example of the present disclosure. FIG. 3 shows an example of creation of a suspected target of FIG. 2. Hereinafter, the examples of the autonomous vehicle and the autonomous driving method for the vehicle according to the present disclosure will be described with reference to FIG. 1, FIG. 2, and FIG. 3.

The examples of the autonomous vehicle and the autonomous driving method for the vehicle according to the present disclosure may be a vehicle and a driving method for the vehicle using a driver assistance function.

Referring to FIG. 1, the autonomous vehicle may include a controller configured to perform the driver assistance function, and the controller may include a first controller 100 configured to create a suspicious target and determine a dangerous situation, a second controller 200 configured to determine an operation of the function or determine whether a driver is careless, and a third controller 300 configured to issue a warning to the driver, for example, in response to the dangerous situation.

The first controller 100 may communicate with each of a front camera 110, a front radar 120, a front-side radar 130, and a navigation system 140 included in the vehicle (e.g., to detect forward objects, monitor lane intrusion, recognize static obstacles, or identify hazardous road segments, etc.). The second controller 200 may communicate with each of an indoor camera 210 and an AVN (Audio, Video & Navigation) 220 included in the vehicle (e.g., to monitor the driver's gaze direction, assess attentiveness, display alerts, or provide visual/audio warnings, etc.). The third controller 300 may communicate with each of a cluster 310, a steering wheel 320, and a seat belt 330 (e.g., via haptic feedback, tightening, or visual/auditory indicators, etc.).

A description will be given of a method of driving the vehicle using the driver assistance function by installing the controller having the above-described configuration in the vehicle (e.g., to manage target recognition, driver monitoring, and hazard warning, etc.).

First, the vehicle may be driven with the driver assistance function turned on (S110). Here, the driver assistance function may be, for example, SCC 2 or HDA 2 (e.g., to maintain distance from a leading vehicle, assist with lane centering, or control speed on highways or curved roads, etc.).

Then, the vehicle is set to a user setting mode (USM), and it is determined whether the vehicle is set to an on state of the USM (S120). Here, the USM means that, during the operation of the driver assistance function, an operation is performed to create and recognize a suspicious target in addition to another control target (e.g., based on reduced sensor reliability thresholds, radar-only detection, or partial lane invasion, etc.).

If the USM is turned on (Yes), it is determined whether the driver is careless (S130). In the determination as to whether the driver is careless, for example, gaze information of the driver is recognized by the indoor camera 210 installed inside the vehicle, and in a situation in which the driver does not pay attention to the front is determined to be careless (Yes) and triggers creation of a suspicious target (S140) (e.g., due to prolonged gaze diversion, closed eyes, or downward head tilt, etc.).

Upon determining that the driver pays attention to the front and is not careless (No), the vehicle may turn on the driver assistance function and continue driving (S110) without activating the USM logic.

If the vehicle is not set to the on state of the USM (No), a process of determining whether the driver is carelessly driving is performed (e.g., by evaluating gaze direction, steering inactivity, or attention lapses, etc.). In more detail, an accumulated carelessness time of the driver is calculated (S122), and it is determined whether the accumulated carelessness time of the driver exceeds, for example, a preset time, such as, 5, 10, or 15 minutes, etc. (S124). Here, whether the driver is careless may be determined using the above-mentioned indoor camera 210 (e.g., by monitoring intermittent attention lapses, failure to focus, or repeated steering disengagement, etc.).

When the accumulated carelessness time of the driver does not exceed, for example, 10 minutes (No), the vehicle may turn on the driver assistance function and continue driving (S110). If the accumulated carelessness time of the driver exceeds, for example, 10 minutes (Yes), the driver is informed that paying attention to the front is necessary, and the vehicle is transitioned to the on state of the USM (S126).

In this instance, the driver may be informed using the above-mentioned AVN 220, for example, audio or video (a screen of a display) of the vehicle or a navigation system, and in the case of the video or the navigation system, the driver may be informed through a modal dialog box (e.g., with a warning icon, pop-up message, or audible notification, etc.). Here, the content provided to the driver may be a message indicating that the vehicle has transitioned to the on state of the USM and the driver needs to continue to pay attention to the front even when such a driver assistance function is used.

Through the above-mentioned process, the driver assistance function may be used so that, if the carelessness time of the driver is accumulated for a certain time, a function described below may be activated by automatically transitioning to the on sate of the USM (e.g., enabling suspicious target generation or enhanced hazard detection, etc.).

Next, a description will be given of a process in which a suspicious target is created, and the suspicious target is utilized to warn the driver (e.g., through visual, auditory, or haptic alerts, etc.).

In a driver assistance function, a criterion for selecting a control target, for example, another vehicle in front of the vehicle or a load on the highway, may be lowered by utilizing the front camera, the front radar, and the front-side radar to select a monitoring target, which is referred to as a “suspicious target” (e.g., a slow-moving vehicle, a stopped vehicle in a tunnel, or a fallen object, etc.).

For example, if a setting criterion of the control target is greater than a first reliability, a creation criterion of the suspicious target may be set to a second reliability, so that a target not previously recognized as the control target may be selected as the suspicious target and monitored. In this case, the first reliability may be 40, and the second reliability may be within a range of 30 to 40.

Here, referring to “reliability”, for example, if consistency between physical values measured by the front camera and the front radar is higher than a threshold value, reliability may be determined to be high (e.g., if both sensors agree on object speed, position, and heading angle, etc.).

A process of creating a suspicious target around a vehicle in motion (S140) may include a process of relaxing a reliability criterion for selecting a target by fusing sensors (S142), changing a method of recognizing a stationary target from sensor fusion to a single front layer (S146) (e.g., a single front radar-based approach), and relaxing a criterion for determining a target that invades the ego lane (S148) (e.g., reducing lateral intrusion threshold from 50% to 10%, etc.).

The process of relaxing the reliability criterion for selecting the target by fusing the sensors will be described in detail as follows.

A method of selecting a target using a sensor may be as follows. For example, if consistency between physical values (for example, longitudinal position, lateral position, speed, heading angle, acceleration, etc.) measured by each of sensors such as the front-side measurement devices installed in the vehicle driving toward a target, for example, the front camera 110, the front radar 120, and the front-side radar 130 is higher than a threshold value, it may be determined that reliability is high (e.g., when positional error margins are within a defined threshold across sensor types, etc.).

In this instance, in this example, the reliability criterion for selecting a target by fusing sensors is relaxed (S142). Specifically, instead of simply summing reliabilities of suspicious targets calculated from each sensor, weights may be applied to the respective reliabilities and summed, for example, based on directional accuracy or sensor characteristics.

For example, the front radar is advantageous in recognition of a longitudinal direction, and thus weights may be applied when selecting the longitudinal position of the target (e.g., for detecting distance to a vehicle or identifying stopped objects ahead, etc.). In addition, the front camera is advantageous in recognition of a lateral direction, and thus weights may be applied when selecting the lateral position of the target (e.g., for distinguishing side-lane objects, road markings, or adjacent vehicles, etc.).

In addition, a target outside a range where recognition is impossible for each sensor may be excluded from reliability selection, and thus may not be selected as a suspicious target (e.g., objects beyond sensor range limits, occluded targets, or targets in sensor blind spots, etc.). In addition, the criterion for selecting a target as a suspicious target may be relaxed when compared to another control target, for example, to expand detection coverage in marginal or ambiguous cases.

In the case of a moving target, for example, a preceding vehicle, it is possible to determine whether the target is a suspicious target based on values measured by the front radar and the front camera using the above method (e.g., when a vehicle suddenly decelerates or cuts in from another lane, etc.). However, the method of recognizing a stationary target may be changed as follows (S146).

For example, in sensor fusion, which performs a determination based on values measured by a plurality of sensors, a determination may be performed based on a value measured by a single sensor. For example, in the case of sensor fusion, accuracy may be increased. However, if a selection time is long due to a plurality of values measured by sensors or if there is a large deviation among the values, selection may be difficult. Therefore, even if accuracy is somewhat reduced, a suspicious target may be selected based on a single value measured by a single sensor, for example, the front radar 120 (e.g., for faster detection of stationary obstacles inside tunnels or near construction sites, etc.).

In addition, the criterion for determining the target that invades the ego lane may be dynamically relaxed (S148), for example, based on the driving context, sensor confidence levels, or driver attentiveness, etc. For example, when another vehicle invades the driving lane from the front or side of the driving vehicle while transitioning from an adjacent lane, although the other vehicle has been selected as the control target when the other vehicle invades the driving lane by 50% in the past, for example, it may be selected as a suspicious target if the invasion exceeds a smaller threshold, such as a first value. Here, the first value may be 10%. Here, 50% invasion and 10% invasion mean that the other vehicle invaded the lane by 50% and 10% of a lateral width, respectively (e.g., due to sudden lane changes, abrupt merges, or misaligned overtaking maneuvers, etc.).

Using the above-described method, a suspicious target is created in the first controller 100 (S140), and the first controller 100 may determine a dangerous situation (e.g., based on proximity, motion trend, or associated navigation data, etc.).

Determination of a dangerous situation may be performed when a suspicious target is selected as described above, or based on specific scenarios in steps S160 to S180 as described below (e.g., highway hazard zones, road debris, or sudden lane intrusions, etc.). In addition, if a suspicious target is recognized (S150) or another dangerous situation is determined (S160 to S180), a warning (S190) may be issued (e.g., immediately or in real time) as a way to alert the driver to take caution (e.g., through visual, auditory, or tactile feedback, etc.). As described below, the warning may be issued by transmitting a dangerous situation flag signal from the third controller 300 to a cluster 310, a steering wheel 320, or a seat belt 330 (e.g., to engage multimodal feedback to regain driver attention, etc.).

First, referring to recognition of a suspicious target (S150), whether a suspicious target is recognized is determined (S150) using a method of relaxing or lowering reliability threshold for selecting a target by sensor fusion (S142), recognizing a stationary target using only a front layer (S146) (e.g., a single front-facing sensor), or relaxing a criterion for determining a target that invades the ego lane (S148) as described above (e.g., based on partial intrusion or abrupt lateral movement, etc.). When the suspicious target is recognized (Yes), the driver may be warned (S190) in real time.

As described above, examples of warning the driver include a method of stimulating sight or hearing of the driver by displaying a warning on a screen or generating a warning sound in the cluster 310, a method of stimulating a sense of touch on a hand of the driver through vibration of the steering wheel 320, or a method of stimulating a sense of touch on a waist or shoulders of the driver by tightening the seat belt 330 (e.g., using a seatbelt pre-tensioner, etc.).

A specific example of suspicious target recognition is as follows.

First, it is possible to determine a highway dangerous section (S160). For example, it is possible to determine whether the vehicle is driven in a dangerous section of a highway or a dedicated automobile road. However, a determination method may differ depending on whether a navigation system is in operation in the vehicle (e.g., based on availability of real-time data or map-based hazard zones, etc.).

For example, if the navigation system is installed and operating in the driving vehicle, the dangerous section of the highway may be determined by utilizing real-time road traffic information from the navigation system. For example, a stagnation zone (red zone), a construction zone, an accident occurrence point, a lane closure, or a reduced-speed enforcement area, etc., may be determined as the dangerous section in the highway. In addition, based on the above-mentioned information of the navigation system, upon determining that there is a dangerous section within a few kilometers (km) ahead on a driving route, this may be determined as a dangerous situation requiring driver attention.

If the navigation system of the driving vehicle is not operating and there is no navigation information, if a suspicious target created by the above-described suspicious target creation method (S140) is recognized, it may be determined that there is a highway dangerous section (e.g., inferred from detected obstacles or abnormal vehicle behavior, etc.).

By using the above-mentioned method, whether a driving vehicle is in the highway dangerous section is determined (S160), and upon determining that a vehicle is in the highway dangerous section (Yes), the driver may be cautioned using the above-mentioned method (S190) (e.g., via a warning pop-up, audible alert, or haptic feedback, etc.).

In addition, it is possible to determine whether there is an obstacle such as a fallen load on the road (S170). For example, it is possible to determine whether there is a dangerous situation by determining whether there is an obstacle such as a fallen load in front of the driving vehicle. However, a determination method may differ depending on whether there is a preceding vehicle in front of the driving vehicle. Here, the obstacle may be a facility in a construction area, road debris, a stopped vehicle, etc., in addition to a fallen load from another vehicle.

When there is a fallen load in front of the driving vehicle, the preceding vehicle may exhibit driving movement to avoid the fallen load (e.g., sudden lane swerve, continuous lateral drift, or abrupt deviation, etc.). For example, if the amount of change in a lateral position of the preceding vehicle is greater than a certain value for a certain period of time, it may be determined that the movement is to avoid the fallen load (e.g., swerving left or right by more than a threshold distance within a few seconds, etc.). Accordingly, by utilizing information collected from the front camera 110 or front radar 120 installed in the driving vehicle, when an evasive driving movement of the preceding vehicle to avoid the fallen load is recognized (e.g., based on sudden lateral deviation or trajectory shift, etc.), a dangerous situation may be determined (Yes).

If there is no preceding vehicle in front of the driving vehicle, it is impossible to recognize the aforementioned driving movement to avoid the fallen load based on leading vehicle behavior. Therefore, when the fallen load is created and recognized as a suspicious target by the aforementioned suspicious target creation method (S140), it is determined that the road is a dangerous section having a falling or fallen load (Yes), and the driver may be warned using the above-mentioned method (S190) (e.g., through cluster display, haptic steering, or seatbelt tensioning, etc.).

In addition, it is possible to determine whether a vehicle is entering the ego lane (the lane in which the driving vehicle is moving) in front of the driving vehicle (S180) (e.g., due to aggressive merging, un-signaled lane changes, or fast approach from adjacent lanes, etc.).

For example, by utilizing information received from the front radar 120 or the front-side radar 130, the first controller 100 calculates a relative position, speed, acceleration, and lateral displacement trend, etc. of the preceding vehicle in the adjacent lane of the driving lane, and when the preceding vehicle in the adjacent lane takes a rapid approach motion toward the ego lane (e.g., sudden lateral intrusion or fast merging), the driving vehicle may determine a dangerous situation (Yes) using the information received as described above and warn the driver as described above (S190).

In this instance, if a relative position change rate and speed change amount of the preceding vehicle, especially a lateral position change rate or speed change amount, is greater than or equal to a certain value, the vehicle may be determined to be rapidly entering the ego lane, and the driver may be warned (S190) before a potential collision risk increases.

The objectives and other advantages of the disclosure may be realized and attained by the structure particularly pointed out in the written description and claims hereof as well as the appended drawings. To achieve these objects and other advantages and in accordance with the purpose of the disclosure, as embodied and broadly described herein, an autonomous vehicle includes a first controller configured to create a suspicious target in front of a driving vehicle and determine a dangerous situation, a second controller configured to determine whether a driver of the driving vehicle is careless, and a third controller configured to issue a warning to the driver upon determining that the driving vehicle is in a dangerous situation and the driver is careless.

The first controller may communicate with at least one of a front camera, a front radar, a front-side radar, or a navigation system installed in front of the driving vehicle.

The second controller may communicate with at least one of an indoor camera or an AVN (Audio, Video & Navigation) installed in the driving vehicle.

The third controller may communicate with at least one of a cluster, a steering wheel, or a seat belt.

A creation criterion of the suspicious target may be lower than a setting criterion of a control target.

In another example of the present disclosure, an autonomous driving method for a vehicle includes setting the vehicle to a user setting mode (USM), creating a suspicious target around the vehicle, determining whether the vehicle is in a dangerous situation from the created suspicious target, and warning a driver of the vehicle if the vehicle is in the dangerous situation.

The setting may include calculating a carelessness time of the driver, and guiding the driver to pay attention to a front and turning on the USM if the carelessness time of the driver exceeds a preset time.

The creating may include creating the suspicious target using a front-side measurement device installed in the vehicle, a creation criterion of the suspicious target being lower than a setting criterion of a control target.

The warning may include warning the driver of the vehicle using at least one of a cluster, a steering wheel, or a seat belt.

The front-side measurement device may be at least one of a front camera or a front radar, the setting criterion of the control target may be greater than or equal to first reliability, and the creation criterion of the suspicious target may be second reliability.

if consistency between physical values measured by the front camera and the front radar is greater than a threshold value, a determination may be made that the reliability is high.

The physical values may include at least one of a longitudinal position, a lateral position, a speed, or a heading angle of the control target or the suspicious target.

When the reliability is determined, a weight may be applied to a lateral position of the control target or the suspicious target measured by a front camera.

When the reliability is determined, a weight may be applied to a longitudinal position of the control target or the suspicious target measured by a front radar.

The creating a suspicious target around the vehicle may include selecting another vehicle in a driving lane adjacent to a driving lane of the vehicle as a suspicious target if the other vehicle invades the driving lane of the vehicle by a first value or more.

The vehicle may be being driven on a highway section, and the suspicious target may be at least one of a stagnation zone, a construction zone, or an accident occurrence point from a navigation system of the vehicle.

The suspicious target may be an obstacle on a road on which the vehicle is being driven.

The suspicious target may be an obstacle on a road on which the vehicle is being driven, and the suspicious target may be created based on avoidance driving movement of a preceding vehicle of the vehicle.

In another example of the present disclosure, a program is recorded on a computer-readable recording medium, wherein the autonomous driving method for the vehicle described above is executed by a processor.

In another example of the present disclosure, a computer-readable recording medium stores the program described above.

According to the autonomous vehicle and the autonomous driving method for the vehicle according to the examples of the present disclosure described above, if the driver is careless while using the driver assistance function, the existing control target selection condition is relaxed to create a new suspicious target, and a warning is issued to draw attention of the driver when recognizing a suspicious target and determining a dangerous situation, thereby reducing a risk of an accident.

In the above description, even though all the components included in the examples of the present disclosure have been described as being combined into one or operating in combination, the present disclosure is not necessarily limited to these examples. For example, within the scope of the purpose of the present disclosure, all of the components may be selectively combined into one or more and operated. In addition, the terms “include”, “comprise”, or “have” described above, unless specifically stated to the contrary, mean that the corresponding components may be included, and therefore should be interpreted to include other components rather than excluding other components. All terms, including technical or scientific terms, unless defined otherwise, have the same meaning as commonly understood by a person of ordinary skill in the art to which the present disclosure pertains. Commonly used terms, such as terms defined in dictionaries, should be interpreted as consistent with meanings thereof in the context of the relevant art, and will not be interpreted in an idealized or overly formal sense, unless explicitly defined in the present disclosure.

The above description is only an illustrative example of the technical idea of the present disclosure, and those skilled in the art to which the present disclosure pertains may make various modifications and variations without departing from the essential characteristics of the present disclosure. Accordingly, the examples published in the present disclosure are not intended to limit the technical idea of the present disclosure but to describe the technical idea, and the scope of the technical idea of the present disclosure is not limited by these examples. The scope of protection of the present disclosure should be interpreted by the claims below, and all technical ideas within a scope equivalent thereto should be interpreted as being included in the scope of rights of the present disclosure.

What is claimed is:

1. An apparatus of a vehicle, the apparatus comprising:
a processor; and
a memory storing at least one instruction that, when executed by the processor communicating with the memory, is configured to cause the apparatus to:
identify a potential target within a threshold distance from the vehicle,
determine, based on the potential target, whether the vehicle is in a dangerous situation,
determine, based on data from a sensor of the vehicle, whether a driver of the vehicle is careless, and
based on determining that the vehicle is in the dangerous situation and the driver is careless, control at least one output interface of the vehicle to output a warning signal to the driver.

2. The apparatus according to claim 1, wherein the at least one instruction, when executed by the processor communicating with the memory, is configured to cause the apparatus to communicate with at least one of a front camera, a front radar, a front-side radar, or a navigation system, wherein the front camera, the front radar, the front-side radar, and the navigation system are installed in a front portion of the vehicle.

3. The apparatus according to claim 1, wherein the at least one instruction, when executed by the processor communicating with the memory, is configured to cause the apparatus to communicate with at least one of an indoor camera or an Audio, Video & Navigation (AVN), wherein the indoor camera and the AVN are installed in the vehicle.

4. The apparatus according to claim 1, wherein the at least one instruction, when executed by the processor communicating with the memory, is configured to cause the apparatus to control at least one of an instrument cluster of the vehicle, a steering wheel of the vehicle, or a seat belt of the vehicle.

5. The apparatus according to claim 1, wherein the potential target is identified based on a criterion that is less stringent than a criterion used for identifying a control target, and wherein the control target refers to an object selected using sensor fusion with a higher threshold of confidence than the potential target.

6. A method performed by an apparatus of a vehicle, the method comprising:
setting, based on determining that a driver of the vehicle is careless, the vehicle to a user setting mode;
identifying, based on the user setting mode, a potential target within a threshold distance from the vehicle;
determining, based on the potential target, whether the vehicle is in a dangerous situation; and
based on determining that the vehicle is in the dangerous situation, controlling at least one output interface of the vehicle to output a warning signal to the driver of the vehicle.

7. The method according to claim 6, wherein the setting comprises:
estimating a time amount of the driver being careless;
guiding the driver to pay attention to a front of the vehicle; and
setting, based on the time amount exceeding a preset time, the vehicle to the user setting mode.

8. The method according to claim 6, wherein the identifying of the potential target comprises identifying the potential target using a front-side measurement device installed in the vehicle, and wherein the potential target is identified based on a criterion that is less stringent than a criterion used for identifying a control target.

9. The method according to claim 6, wherein the controlling comprises outputting the warning signal to the driver of the vehicle using at least one of an instrument cluster of the vehicle, a steering wheel of the vehicle, or a seat belt of the vehicle.

10. The method according to claim 8, wherein:
the front-side measurement device is at least one of a front camera of the vehicle or a front radar of the vehicle, and
the control target is identified based on satisfying a first reliability threshold, and the potential target is identified based on satisfying a second reliability threshold that is lower than the first reliability threshold.

11. The method according to claim 10, further comprising, based on a consistency between physical values measured by the front camera and the front radar being satisfactory, determining that a reliability value associated with the control target satisfies the first reliability threshold.

12. The method according to claim 11, wherein the physical values comprise at least one of a longitudinal position of a detected object, a lateral position of the detected object, a speed of the detected object, or a heading angle of the detected object, wherein the detected object is the control target.

13. The method according to claim 8, wherein the identifying of the potential target comprises:
determining, based on sensor measurements, a reliability value by applying a weight to a lateral position of the control target or a lateral position of the potential target, and wherein the lateral position of the control target or the lateral position of the potential target are measured by a front camera of the vehicle.

14. The method according to claim 8, wherein the identifying of the potential target comprises:
determining, based on sensor measurements, a reliability value by applying a weight to a longitudinal position of the control target or a longitudinal position of the potential target, wherein the longitudinal position of the control target or the longitudinal position of the potential target are measured by a front radar of the vehicle.

15. The method according to claim 8, wherein the identifying of the potential target comprises selecting another vehicle located in a lane adjacent to a driving lane of the vehicle as the potential target based on the other vehicle encroaching into the driving lane of the vehicle by at least a first threshold amount.

16. The method according to claim 6, wherein:
the vehicle is being driven on a highway section, and
the potential target comprises at least one of a stagnation zone, a construction zone, or an accident occurrence point, wherein each of the stagnation zone, the construction zone, and the accident occurrence point is identified based on information received from a navigation system of the vehicle.

17. The method according to claim 8, wherein the potential target is an obstacle on a road on which the vehicle is being driven.

18. The method according to claim 8, wherein:
the potential target is an obstacle on a road on which the vehicle is being driven, and
the potential target is identified based on avoidance driving movements of a preceding vehicle traveling ahead of the vehicle.

19. An apparatus of a vehicle, the apparatus comprising:
a processor; and
a memory storing at least one instruction that, when executed by the processor communicating with the memory, is configured to cause the apparatus to:
determine that a cumulative carelessness time of a driver of the vehicle exceeds a threshold time,
set, based on the determination, the vehicle to a user setting mode,
receive sensor data indicating a surrounding environment within a threshold distance from the vehicle,
identify, based on the sensor data, a potential target, wherein the potential target is identified using a criterion that is less stringent than a criterion used for identifying a control target,
determine, based on the potential target, whether the vehicle is in a dangerous situation, and
based on determining that the driver is careless and that the vehicle is in the dangerous situation, control an output device of the vehicle to output a warning signal to the driver.

20. The apparatus of claim 19, wherein the at least one instruction, when executed by the processor communicating with the memory, is configured to cause the apparatus to determine the cumulative carelessness time based on gaze information of the driver obtained from an indoor camera of the vehicle,
wherein the driver is determined to be careless based on a duration during which the driver does not gaze forward exceeding a gaze threshold time, and
wherein the cumulative carelessness time is incremented based on the duration exceeding the gaze threshold time.
